(19) United States
(12) Patent Application Publication
(10) Pub. No.: US 2015/0377267 A1
(43) Pub. Date: Dec. 31, 2015

(54) ELASTICALLY AVERAGED ALIGNMENT SYSTEMS AND METHODS

(71) Applicant: GM GLOBAL TECHNOLOGY OPERATIONS LLC, Detroit, MI (US)

(72) Inventors: Steven E. Morris, Fair Haven, MI (US); Vincent L. Ruma, Clarkston, MI (US); Jennifer P. Lawall, Waterford, MI (US); Michael Coules, New Baltimore, MI (US)

(21) Appl. No.: 14/319,508

(22) Filed: Jun. 30, 2014

(51) Int. Cl. F16B 5/07

(52) U.S. Cl. CPC F16B 5/07

(57) ABSTRACT

In one aspect, an elastically averaged alignment system is provided. The system includes a first component having opposed curved first and second alignment members and a second component having an inner wall defining an alignment aperture. The inner wall includes a first edge and an opposed second edge, and the curved first and second alignment members are an elastically deformable material such that when the opposed curved first and second alignment members are inserted into the alignment aperture, the curved first and second alignment members elastically deform to an elastically averaged final configuration to facilitate aligning the first component within the aperture of the second component in a desired orientation.

### FIELD OF THE INVENTION

The subject invention relates to matable components and, more specifically, to elastically averaged matable components for alignment and retention.

### BACKGROUND

Components, in particular vehicular components used in automotive vehicles, which are to be mated together in a manufacturing process may be mutually located with respect to each other by alignment features that are oversized holes and/or undersized upstanding bosses. Such alignment features are typically sized to provide spacing to freely move the components relative to one another to align them without creating an interference therebetween that would hinder the manufacturing process. One such example includes two-way and/or four-way male alignment features; typically upstanding bosses, which are received into corresponding female alignment features, typically apertures in the form of slots or holes. The components are formed with a predetermined clearance between the male alignment features and their respective female alignment features to match anticipated size and positional variation tolerances of the male and female alignment features that result from manufacturing (or fabrication) variances.

Significant positional variation can occur between two mated components having the aforementioned alignment features, which may contribute to the presence of undesirably large variation in their alignment, particularly with regard to gaps and/or spacing therebetween. In the case where misaligned components are also part of another assembly, such misalignment may also affect the function and/or aesthetic appearance of the entire assembly. Regardless of whether such misalignment is limited to two components or an entire assembly, it can negatively affect function and result in a perception of poor quality. Moreover, clearance between misaligned components may lead to relative motion therebetween, which may cause undesirable noise such as squeaking and rattling.

### SUMMARY OF THE INVENTION

In one aspect, an elastically averaged alignment system is provided. The system includes a first component having opposed curved first and second alignment members and a second component having an inner wall defining an alignment aperture. The inner wall includes a first edge and an opposed second edge, and the curved first and second alignment members are an elastically deformable material such that when the opposed curved first and second alignment members are inserted into the alignment aperture, the curved first and second alignment members elastically deform to an elastically averaged final configuration to facilitate aligning the first component within the aperture of the second component in a desired orientation.

In another aspect, a vehicle is provided. The vehicle includes a body and an elastically averaged alignment system integrally arranged within the body. The elastically averaged alignment system includes a first component having opposed curved first and second alignment members and a second component having an inner wall defining an alignment aperture. The inner wall includes a first edge and an opposed second edge, and the curved first and second alignment members are an elastically deformable material such that when the opposed curved first and second alignment members are inserted into the alignment aperture, the curved first and second alignment members elastically deform to an elastically averaged final configuration to facilitate aligning the first component within the aperture of the second component in a desired orientation.

In yet another aspect, a method of manufacturing an elastically averaged alignment system is provided. The method includes forming a first component having opposed curved first and second alignment members, forming a second component having an inner wall defining an alignment aperture, the inner wall having a first edge and an opposed second edge, and forming the curved first and second alignment members from an elastically deformable material such that when the opposed curved first and second alignment members are inserted into the alignment aperture, the curved first and second alignment members elastically deform to an elastically averaged final configuration to facilitate aligning the first component within the aperture of the second component in a desired orientation.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a perspective view of an exemplary elastically averaging mating system before assembly;

FIG. 2 is a perspective view of the system shown in FIG. 1 after assembly;

FIG. 3 is a cross-sectional view of the system shown in FIG. 2 taken along section 3-3;

FIG. 4 is a cross-sectional view of the system shown in FIG. 2 taken along section 4-4; and

FIG. 5 is a rear view of a vehicle that may use the elastically averaged alignment system shown in FIGS. 1-4.

### DETAILED DESCRIPTION

The following description is merely exemplary in nature and is not intended to limit the present disclosure, its application or uses. For example, the embodiments shown are applicable to vehicle components, but the system disclosed herein may be used with any suitable components to provide securement and elastic averaging for precision location and alignment of all manner of mating components and component applications, including many industrial, consumer product (e.g., consumer electronics, various appliances and the like), transportation, energy and aerospace applications, and particularly including many other types of vehicular components and applications, such as various interior, exterior, electrical and under hood vehicular components and applications. It should be understood that throughout the drawings, corresponding reference numerals indicate like or corresponding parts and features.

As used herein, the term “elastically deformable” refers to components, or portions of components, including component features, comprising materials having a generally elastic deformation characteristic, wherein the material is configured to undergo a resiliently reversible change in its shape, size, or both, in response to the application of a force. The force causing the resiliently reversible or elastic deformation of the material may include a tensile, compressive, shear, bending or torsional force, or various combinations of these forces. The elastically deformable materials may exhibit linear elastic deformation, for example that described according to Hooke's law, or non-linear elastic deformation.

Elastic averaging provides elastic deformation of the interface(s) between mated components, wherein the average deformation provides a precise alignment, the manufacturing positional variance being minimized to Xₘᵢₙ, defined by Xₘᵢₙ=X/√N, wherein X is the manufacturing positional variance of the locating features of the mated components and N is the number of features inserted. To obtain elastic averaging, an elastically deformable component is configured to have at least one feature and its contact surface(s) that is over-constrained and provides an interference fit with a mating feature of another component and its contact surface(s). The over-constrained condition and interference fit resiliently reversibly (elastically) deforms at least one of the at least one feature or the mating feature, or both features. The resiliently reversible nature of these features of the components allows repeatable insertion and withdrawal of the components that facilitates their assembly and disassembly. In some embodiments, the elastically deformable component configured to have the at least one feature and associated mating feature disclosed herein may require more than one of such features, depending on the requirements of a particular embodiment. Positional variance of the components may result in varying forces being applied over regions of the contact surfaces that are over-constrained and engaged during insertion of the component in an interference condition. It is to be appreciated that a single inserted component may be elastically averaged with respect to a length of the perimeter of the component. The principles of elastic averaging are described in detail in commonly owned U.S. Pat. No. 8,695,201, the disclosure of which is incorporated by reference herein in its entirety. The embodiments disclosed above provide the ability to convert an existing component that is not compatible with the above-described elastic averaging principles, or that would be further aided with the inclusion of an elastic averaging system as herein disclosed, to an assembly that does facilitate elastic averaging and the benefits associated therewith.

Any suitable elastically deformable material may be used for the mating components and alignment features disclosed herein and discussed further below, particularly those materials that are elastically deformable when formed into the features described herein. This includes various metals, polymers, ceramics, inorganic materials or glasses, or composites of any of the aforementioned materials, or any other combinations thereof suitable for a purpose disclosed herein. Many composite materials are envisioned, including various filled polymers, including glass, ceramic, metal and inorganic material filled polymers, particularly glass, metal, ceramic, inorganic or carbon fiber filled polymers. Any suitable filler morphology may be employed, including all shapes and sizes of particulates or fibers. More particularly any suitable type of fiber may be used, including continuous and discontinuous fibers, woven and unwoven cloths, felts or tows, or a combination thereof. Any suitable metal may be used, including various grades and alloys of steel, cast iron, aluminum, magnesium or titanium, or composites thereof, or any other combinations thereof. Polymers may include both thermoplastic polymers or thermoset polymers, or composites thereof, or any other combinations thereof, including a wide variety of co-polymers and polymer blends. In one embodiment, a preferred plastic material is one having elastic properties so as to deform elastically without fracture, as for example, a material comprising an acrylonitrile butadiene styrene (ABS) polymer, and more particularly a polycarbonate ABS polymer blend (PC/ABS). The material may be in any form and formed or manufactured by any suitable process, including stamped or formed metal, composite or other sheets, forgings, extruded parts, pressed parts, castings, or molded parts and the like, to include the deformable features described herein. The elastically deformable alignment features and associated component may be formed in any suitable manner. For example, the elastically deformable alignment features and the associated component may be integrally formed, or they may be formed entirely separately and subsequently attached together. When integrally formed, they may be formed as a single part from a plastic injection molding machine, for example. When formed separately, they may be formed from different materials to provide a predetermined elastic response characteristic, for example. The material, or materials, may be selected to provide a predetermined elastic response characteristic of any or all of the elastically deformable alignment features, the associated component, or the mating component. The predetermined elastic response characteristic may include, for example, a predetermined elastic modulus.

As used herein, the term vehicle is not limited to just an automobile, truck, van or sport utility vehicle, but includes any self-propelled or towed conveyance suitable for transporting a burden.

Described herein are elastic averaging alignment systems and methods. The alignment systems include a component with an alignment aperture to receive curved, elastically deformable alignment members of another component. The curved alignment members are configured to be inserted into the alignment aperture, and the alignment members elastically deform to facilitate precisely aligning and securing the components together in a desired orientation.

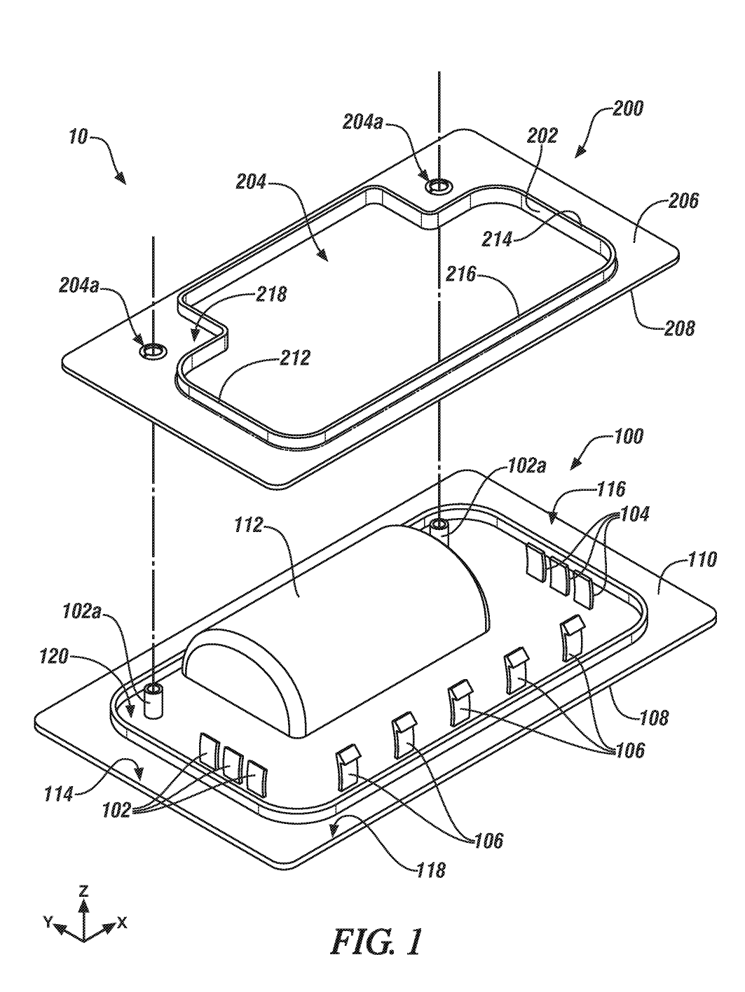

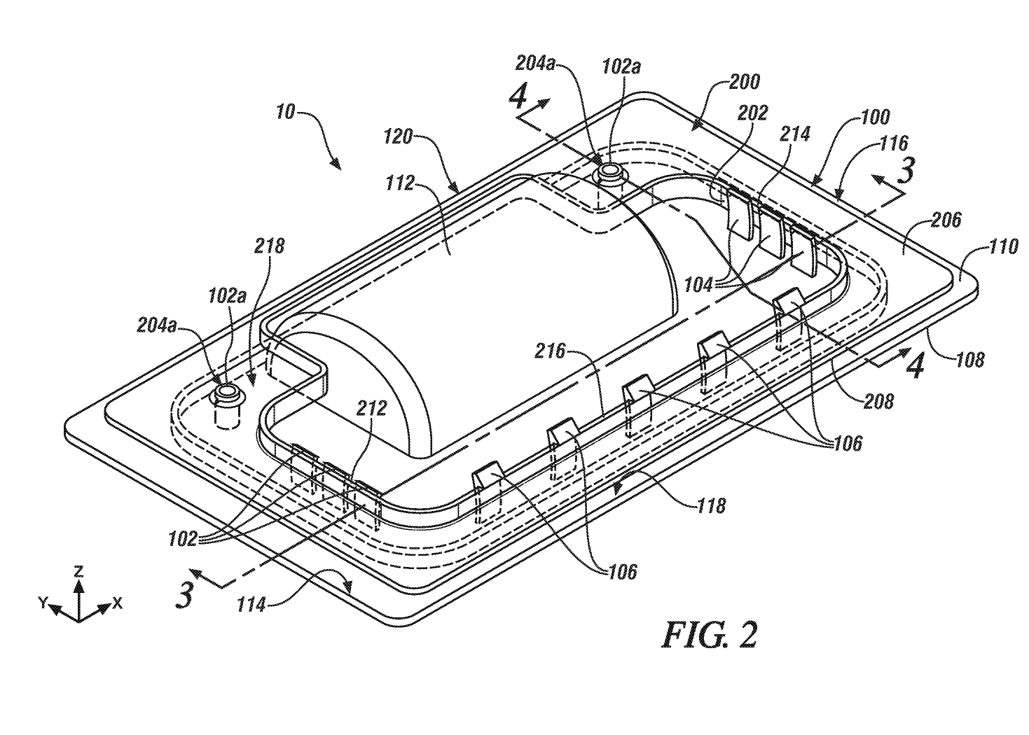

FIGS. 1 and 2 illustrate an exemplary elastically averaged alignment system 10 that generally includes a first component 100 to be mated to a second component 200.

In the exemplary embodiment, first component 100 includes opposed curved elastically deformable alignment tabs or members 102 and 104 and curved elastically deformable alignment tabs or members 106, and second component 200 includes an inner wall 202 defining an alignment aperture 204. Alignment members 102, 104, 106 and alignment aperture 204 are fixedly disposed on or formed integrally with their respective component 100, 200 for proper alignment and orientation when components 100 and 200 are mated. In an unmated position (FIG. 1), alignment members 102, 104, 106 are convexly shaped and curved inward toward each other or toward a center of first component 100. In a mated position (FIG. 2), alignment members 102, 104, 106 are elastically deformed further toward each other or toward a center of first component 100. Although three alignment members 102, 104, five alignment members 106, and one corresponding alignment aperture 204 are illustrated in FIG. 1, components 100 and 200 may have any number and combination of corresponding alignment members 102, 104, 106 and alignment apertures 204. Further, as shown in FIGS. 1 and 2, first component 100 may include additional tubular alignment members 102a corresponding to additional alignment apertures 204a.

Elastically deformable alignment members 102, 104, 106 are configured and disposed to interferingly, deformably, and matingly engage inner wall 202 of alignment aperture 204, as discussed herein in more detail, to precisely align first component 100 with second component 200 in two or four directions, such as the +/−x-direction and the +/−y-direction of an orthogonal coordinate system, for example, which is herein referred to as two-way and four-way alignment. Similarly, alignment members 102a are configured and disposed to interferingly, deformably, and matingly engage alignment apertures 204a to precisely align first and second components 100, 200 in four-way alignment Elastically deformable alignment members 102, 104, 106 matingly engage inner wall 202 of alignment aperture 204 to facilitate a stiff and rigid connection between first component 100 and second component 200, thereby reducing or preventing relative movement therebetween.

In the exemplary embodiment, first component 100 generally includes an outer face 108 and an inner face 110 from which alignment members 102, 104, and 106 and a projection 112 extend. More specifically, first component 100 includes a first edge portion 114 from which alignment members 102 extend, a second edge portion 116 from which alignment members 104 extend, a third edge portion 118 from which alignment members 106 extend, and a fourth edge portion 120 from which alignment members 102a extend. Alternatively, fourth edge portion 120 may include features such as alignment members 102 and/or 106. In one embodiment, third edge portion 118 and alignment members 106 are oriented orthogonally to first and second edge portions 114, 116 and alignment members 102, 104.

As shown in FIGS. 1-4, alignment members 102, 104, 106 are each a generally rectangular, solid member having a proximal end 122 coupled to inner face 110, and a distal end 124. Alignment members 102a are generally circular tubes having a proximal end 122a coupled to inner face 110, and a distal end 124a. However, alignment members 102, 104, 106, 102a may have any cross-sectional shape that enables system 10 to function as described herein. Projection 112 may be hollow to define a cavity (not shown) formed in first component outer face 108.

Distal end 124 of alignment members 106 includes a retention member 126 extending outwardly from an alignment member outer surface 103 and configured to engage second component 200. In the exemplary embodiment, first component 100 is fabricated from a rigid material such as plastic. However, first component 100 may be fabricated from any suitable material that enables system 10 to function as described herein.

Second component 200 generally includes an outer face 206 and an inner face 208. Inner wall 202 is at least partially defined by a perimeter flange 210 extending from outer face 206, and aperture 204 includes opposed first and second edges 212 and 214, and opposed third and fourth edges 216 and 218. In the exemplary embodiment, alignment apertures 204a are illustrated as having a generally circular cross-section. Alternatively, alignment apertures 204a may have any shape that enables system 10 to function as described herein such as, for example, an elongated slot. In the exemplary embodiment, second component 200 is fabricated from a rigid material such as sheet metal. However, second component 200 may be fabricated from any suitable material that enables system 10 to function as described herein.

While not being limited to any particular structure, first component 100 may be a door handle base of a vehicle with the customer-visible side being outer face 108, and projection 112 defines a cavity to receive a door handle. Second component 200 may be a supporting substructure that is part of, or is attached to, the vehicle and on which first component 100 is fixedly mounted in precise alignment.

To provide an arrangement where elastically deformable alignment members 102, 104, 106 are configured and disposed to interferingly, deformably and matingly engage alignment aperture 204, alignment members 102, 104, 106 are oriented at positions that are slightly beyond the size of the perimeter of alignment aperture 204, which necessarily creates a purposeful interference fit between the elastically deformable alignment members 102, 104, 106 and alignment aperture 204. As such, when inserted into alignment aperture 204, portions of the elastically deformable alignment members 102, 104, 106 elastically deform to an elastically averaged final configuration that aligns first component 100 within the alignment aperture 204 in four planar orthogonal directions (the +/−x-direction and the +/−y-direction). For example, as shown in FIG. 2, first component projection 112 is centered within aperture 204.

To provide an arrangement where elastically deformable alignment member 102a is configured and disposed to interferingly, deformably, and matingly engage alignment aperture 204a, the diameter or cross-section of each alignment aperture 204a is smaller than the diameter or cross-section of alignment member 102a, which necessarily creates a purposeful interference fit between the elastically deformable alignment member 102a and alignment aperture 204a. As such, when inserted into alignment aperture 204a, portions of the elastically deformable alignment member 102a elastically deform to an elastically averaged final configuration that aligns alignment member 102a with the alignment aperture 204a in four planar orthogonal directions (the +/−x-direction and the +/−y-direction). Where alignment aperture 204a is an elongated slot (not shown), alignment member 102 is aligned in two planar orthogonal directions (the +/−x-direction or the +/−y-direction). However, alignment aperture 204a may have any suitable shape that enables system 10 to function as described herein.

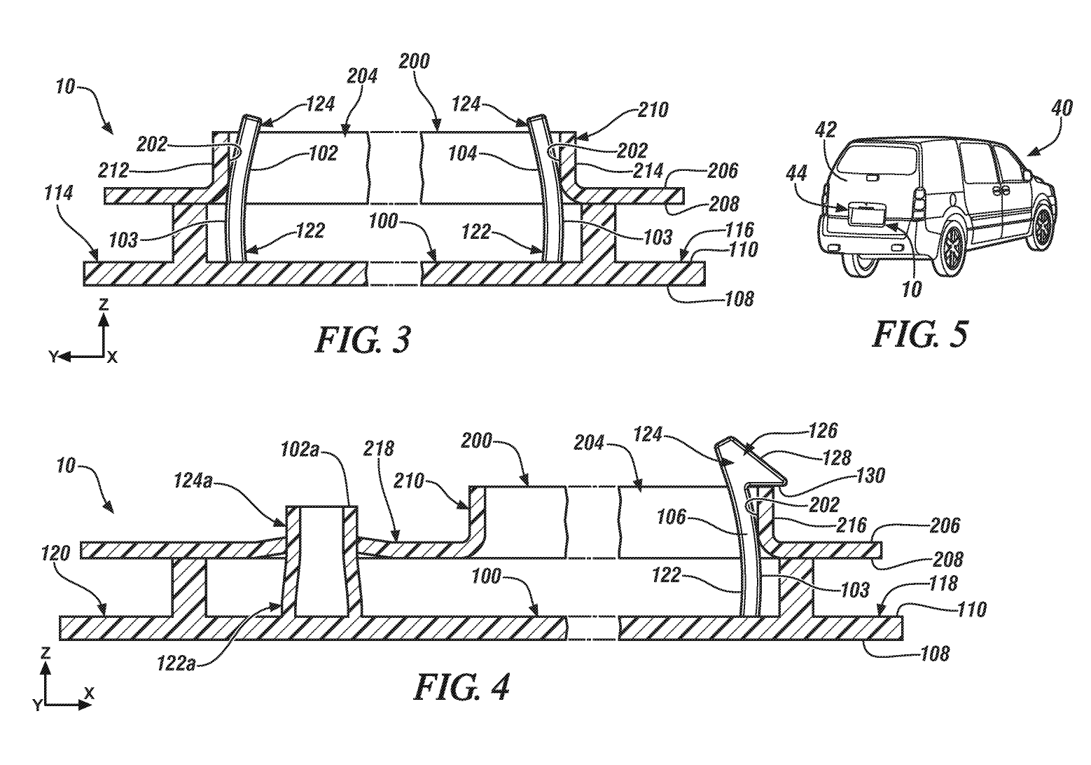

FIG. 3 illustrates an exemplary orientation of opposed alignment members 102 and 104 after assembly between first component 100 and second component 200. As shown, outer surface 103 of curved alignment members 102, 104 (i.e., along the radius of the curve) contact inner wall 202 of respective first and second edges 212 and 214, and alignment members 102, 104 elastically deform toward each other to align first component 100 in a desired orientation relative to second component 200. For example, the elastic averaging of alignment members 102, 104 centers first component projection 112 within alignment aperture 204 along the +/−x-direction.

FIG. 4 illustrates an exemplary orientation of alignment members 106 and 102a after assembly between first component 100 and second component 200. As shown, outer surface 103 of curved alignment member 106 (i.e., along the radius of the curve) contacts inner wall 202 of third edge 216, and alignment members 102a, 106 elastically deform toward each other to align first component 100 in a desired orientation relative to second component 200. For example, the elastic averaging of alignment members 106 and 102a centers first component projection 112 within alignment aperture along the +/−y-direction. In addition, although not shown, opposed alignment members 102a may also elastically deform to align component 100 in a desired+/−x-direction orientation relative to second component 200.

In the exemplary embodiment, alignment members 106 include retention member 126 to facilitate retention of alignment member 106 within alignment aperture 204 and against third edge 216. In the exemplary embodiment, retention member 126 includes an insertion surface 128 and a retention surface 130. Insertion surface 128 extends angularly from alignment member outer surface 103 and facilitates insertion of alignment member 106 into alignment aperture 204. After insertion, retention surface 130 engages third edge 216 to facilitate preventing alignment member 106 from backing out or otherwise being removed from alignment aperture 204. In the exemplary embodiment, retention member 126 has a triangular cross-section. Alternatively, retention member 126 may have any suitable shape that enables system 10 to function as described herein. Accordingly, retention member 126 facilitates improved retention of alignment members 106 within alignment apertures 204. In addition, alignment members 102, 102a, and/or 104 may include a retention member 126.

In view of the foregoing, and with reference now to FIG. 5, it will be appreciated that an embodiment of the invention also includes a vehicle 40 having a body 42 with an elastically averaging alignment system 10 as herein disclosed integrally arranged with the body 42. In the embodiment of FIG. 5, elastically averaging alignment system 10 is depicted forming at least a portion of a liftgate handle 44 of the vehicle 40. However, it is contemplated that an elastically averaging alignment system 10 as herein disclosed may be utilized with other multi-layered components of the vehicle 40, such as body/side trim, air vents/dams, trim appliques, door lock/release systems, grilles, lighting, and housing.

An exemplary method of manufacturing elastically averaged alignment system 10 includes forming first component 100 with opposed curved alignment members 102, 104 and at least one curved alignment member 106, and forming or providing second component 200 with inner wall 202 defining alignment aperture 204. Alignment members 102, 104, 106 are formed to be elastically deformable such that when alignment members 102, 104, 106 are inserted into alignment aperture 204, curved alignment members 102, 104, 106 elastically deform against inner wall 202 to an elastically averaged final configuration to facilitate aligning first component 100 with respect to second component 200 in a desired orientation. First and second components 100, 200 may be formed with respective alignment members 102a and alignment apertures 204a, and alignment members 102, 102a, 104, 106 may be formed with one or more retention member 126.

Systems and methods for elastically averaging mating and alignment systems are described herein. The systems generally include a first component with curved elastically deformable alignment members positioned for insertion into an alignment aperture of a second component. The mating of the first and second components is elastically averaged over the curved alignment members and alignment aperture to precisely mate the components in a desired orientation. Moreover, the alignment members may include retention members to facilitate retention of alignment members within the alignment aperture. Accordingly, the described systems and methods facilitate precise alignment of two or more components in a desired orientation.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. An elastically averaged alignment system comprising:
a first component comprising opposed curved first and second alignment members; and
a second component comprising an inner wall defining an alignment aperture, the inner wall having a first edge and an opposed second edge,
wherein the curved first and second alignment members are an elastically deformable material such that when the opposed curved first and second alignment members are inserted into the alignment aperture, the curved first and second alignment members elastically deform to an elastically averaged final configuration to facilitate aligning the first component within the aperture of the second component in a desired orientation.

2. The system of claim 1, wherein the first component further comprises a curved third alignment member, and the second component inner wall includes a third edge.

3. The system of claim 2, wherein the curved third alignment member is oriented orthogonally to the first and second curved alignment members, and the third edge is oriented orthogonally to the first and second edges.

4. The system of claim 3, wherein the curved third alignment member comprises a retention member extending therefrom.

5. The system of claim 4, wherein the retention member includes an angularly extending insertion face configured to facilitate insertion of the curved third alignment member into the alignment aperture, and a retention face configured to engage a portion of the second component to facilitate preventing removal of the curved third alignment member from the alignment aperture.

6. The system of claim 1, wherein the curved first alignment member is configured to engage the inner wall first edge, and the curved second alignment member is configured to engage the inner wall second edge.

7. The system of claim 1, wherein the curved first and second alignment members curve towards each other.

8. The system of claim 2, wherein the first component further comprises a tubular fourth alignment member, and the second component further comprises a second inner wall defining a second alignment aperture, wherein the fourth alignment member is an elastically deformable material such that when the fourth alignment member is inserted into the second alignment aperture the fourth alignment member elastically deforms to an elastically averaged final configuration to further facilitate aligning the first component and the second component in the desired orientation.

9. The system of claim 1, wherein the first component comprises more than one of each of the elastically deformable curved first and second alignment members, the more than one of the elastically deformable curved first and second alignment members being geometrically distributed with respect to the alignment aperture, such that portions of the elastically deformable curved first and second alignment members, when engaged with the alignment aperture inner wall, elastically deform to an elastically averaged final configuration that further aligns the first component with the second component in at least two of four planar orthogonal directions.

10. A vehicle comprising:
a body; and
an elastically averaged alignment system integrally arranged within the body, the elastically averaged alignment system comprising:
a first component comprising opposed curved first and second alignment members; and
a second component comprising an inner wall defining an alignment aperture, the inner wall having a first edge and an opposed second edge,
wherein the curved first and second alignment members are an elastically deformable material such that when the opposed curved first and second alignment members are inserted into the alignment aperture, the curved first and second alignment members elastically deform to an elastically averaged final configuration to facilitate aligning the first component within the aperture of the second component in a desired orientation.

11. The vehicle of claim 10, wherein the first component further comprises a curved third alignment member, and the second component inner wall includes a third edge.

12. The vehicle of claim 11, wherein the curved third alignment member is oriented orthogonally to the first and second curved alignment members, and the third edge is oriented orthogonally to the first and second edges.

13. The vehicle of claim 12, wherein the curved third alignment member comprises a retention member extending therefrom.

14. The vehicle of claim 13, wherein the retention member includes an angularly extending insertion face configured to facilitate insertion of the curved third alignment member into the alignment aperture, and a retention face configured to engage a portion of the second component to facilitate preventing removal of the curved third alignment member from the alignment aperture.

15. The vehicle of claim 10, wherein the curved first alignment member is configured to engage the inner wall first edge, and the curved second alignment member is configured to engage the inner wall second edge.

16. The vehicle of claim 10, wherein the curved first and second alignment members curve towards each other.

17. The vehicle of claim 11, wherein the first component further comprises a curved fourth alignment member, and the second component inner wall includes a fourth edge, wherein the curved third and fourth alignment members are opposed and the third and fourth edges are opposed.

18. The vehicle of claim 10, wherein the first component comprises more than one of each of the elastically deformable curved first and second alignment members, the more than one of the elastically deformable curved first and second alignment members being geometrically distributed with respect to the alignment aperture, such that portions of the elastically deformable curved first and second alignment members, when engaged with the alignment aperture inner wall, elastically deform to an elastically averaged final configuration that further aligns the first component with the second component in at least two of four planar orthogonal directions.

19. A method of manufacturing an elastically averaged alignment system, the method comprising:
forming a first component having opposed curved first and second alignment members;
forming a second component having an inner wall defining an alignment aperture, the inner wall having a first edge and an opposed second edge; and
forming the curved first and second alignment members from an elastically deformable material such that when the opposed curved first and second alignment members are inserted into the alignment aperture, the curved first and second alignment members elastically deform to an elastically averaged final configuration to facilitate aligning the first component within the aperture of the second component in a desired orientation.

20. The method of claim 19, further comprising forming the first component with curved third alignment members.
